(19) United States
(12) Patent Application Publication
(10) Pub. No.: US 2011/0154396 A1
(43) Pub. Date: Jun. 23, 2011

(54) METHOD AND SYSTEM FOR CONTROLLING IPTV SERVICE USING MOBILE TERMINAL

(75) Inventors: Kwihoon KIM, Daejeon (KR); Seng Kyoun Jo, Chungcheongbuk-do (KR); Hyun Woo Lee, Daejeon (KR); Won Ryu, Daejeon (KR)

(73) Assignee: Electronics and Telecommunications Research Institute, Daejeon (KR)

(21) Appl. No.: 12/900,512

(22) Filed: Oct. 8, 2010

(30) Foreign Application Priority Data
Dec. 18, 2009 (KR) 10-2009-0127449

(51) Int. Cl. H04N 5/445; H04N 7/173

(52) U.S. Cl. 725/40; 725/38; 725/110

(57) ABSTRACT

Provided is a method for providing an Internet Protocol television (IPTV) service using a mobile terminal. A mobile terminal of an IPTV service control system may include a viewpoint recognition unit to obtain information about a viewpoint where a user is viewing, a viewpoint processing unit to compute position coordinates corresponding to the viewpoint by comparing a screen displayed on the mobile terminal with the information about the viewpoint, and a set-top control client to display the same screen as a screen of a TV on the to mobile terminal, and to enable the set-top box to display a selection icon on the same position as a position indicated by the position coordinates of the TV.

### CROSS-REFERENCE TO RELATED APPLICATION

This application claims the benefit of Korean Patent Application No. 10-2009-0127449, filed on Dec. 18, 2009, in the Korean Intellectual Property Office, the disclosure of which is incorporated herein by reference.

### BACKGROUND

1. Field of the Invention

Embodiments of the present invention relate to a method of providing an Internet Protocol Television (IPTV) service using a mobile terminal, and more particularly, to a service control method that may control an IPTV service using a viewpoint, a lip-blowing, and a touch of a user.

2. Description of the Related Art

An Internet Protocol Television (IPTV) service may be a service that provides information services, moving picture contents, and broadcasting services through a TV using a very-high speed network.

The IPTV may have similarity with a general cable broadcasting or satellite broadcasting in that videos and broadcasting contents are provided, however, have difference with the cable broadcasting and satellite broadcasting in that a bidirectional property is added.

Specifically, unlike a general terrestrial broadcasting, the cable broadcasting, and the satellite broadcasting, the IPTV may have a function to allow a viewer to view only programs desired by the viewer at a time that is convenient to the viewer.

However, to realize the function, a number of corresponding contents and services may increase and thus, it is difficult to navigate the increased number of contents and services using a TV remote control.

To overcome this problem, a viewpoint control technology has been used, however, it is difficult to distinguish whether a viewpoint where a user is viewing corresponds to a viewpoint where the user is simply viewing TV contents, or is viewing a viewpoint for Electronic Program Guide (EPG) control.

To distinguish between the two viewpoints, a method, in which a timer is used, where the viewpoint is determined as the viewpoint for the EPG control when a period of time during which a viewpoint remains on corresponding coordinates is relatively long has to been used. However, since a predetermined time required for a single selection input is needed, a period of time required for a selection performed for the EPG control disadvantageously increase.

Also, a conventional IPTV service may allow only channels a subscriber has rights to view as established in a Set-Top Box (STB) that is based on a fixed rate system and thus, a subscriber of a specific IPTV service may need to move the subscriber's own STB or an authority Conditional Access System (CAS) card when the subscriber desires to view a TV in another place different from the subscriber's home, thereby causing inconvenience.

Accordingly, there is a demand for a system and method that may readily and rapidly control the IPTV service using a viewpoint, and may allow a user to use the IPTV service even in another place different from the user's home since a user authentication is successfully performed even without using the SIB.

### SUMMARY

An aspect of the present invention provides a system for controlling an Internet Protocol television (IPTV) service that may recognize a viewpoint where a user is viewing using a mobile terminal and thus, control an IPTV using the viewpoint without using a separate viewpoint sensing camera.

An aspect of the present invention also provides a system for controlling an IPTV service that may measure a lip-blowing of a user using a microphone of a mobile terminal, and perform a left-click, a right-click, a double click, and a drag and drop of a mouse depending on a type of the lip-blowing and thus, directly performing a desired operation of the user without fixing a viewpoint of the user for a predetermined period of time.

An aspect of the present invention also provides a system for controlling an IPTV service that may control an IPTV using a mobile terminal where a touch screen is mounted and thus, performing an elaborate control on the IPTV using the touch screen.

An aspect of the present invention also provides a system for controlling an IPTV service that may perform a user authentication using an eyeball image of a user that is photographed by a mobile terminal and thus, easily perform the user authentication even in a Set-Top Box (STB) which the user does not frequently use, to thereby be readily provided with the IPTV services.

According to an aspect of the present invention, there is provided mobile terminal of a system for controlling an IPTV service, the mobile terminal including: a viewpoint recognition unit to obtain information about a viewpoint where a user is viewing; a viewpoint processing unit to compute position coordinates corresponding to the viewpoint by comparing a screen displayed on the mobile terminal with the information about the viewpoint; and a set-top control client to display the same screen as a screen of a television (TV) on the mobile terminal, and to enable the set-top box to display a selection icon on the same position as a position indicated by the position coordinates of the TV.

According to another aspect of the present invention, there is provided a set-top box of a system for controlling an IPTV service, including: a set-top control server unit to receive, from a mobile terminal, position information selected by a user based on a viewpoint of the user; an Electronic Program Guide (EPG) control unit to display an EPG on a TV screen, and to further display a selection icon on the EPG based on the position information; and a screen conversion unit to convert the TV screen displayed by the EPG control unit to an EPG image/data corresponding to a format of the mobile terminal, and to transmit the converted EPG image/data to the mobile terminal.

According to still another aspect of the present invention, there is provided a method for controlling an IPTV service, the method including: displaying, by a mobile terminal, the same screen as a screen of a TV; measuring, by the mobile terminal, a viewpoint of a user; computing, by the mobile terminal, position coordinates based on the viewpoint by comparing the viewpoint with screen information displayed on the mobile terminal; and to transmitting, by the mobile terminal, the position coordinates to a set-top box to enable the set-top box to display a selection icon on the same position as a position indicated by the position coordinates of the TV.

Additional aspects, features, and/or advantages of the invention will be set forth in part in the description which follows and, in part, will be apparent from the description, or may be learned by practice of the invention.

### EFFECT

According to embodiments of the present invention, there is provided a system for controlling an Internet Protocol television (IPTV) service that may recognize a viewpoint where a user is viewing, using a mobile terminal and thus, control an IPTV using the viewpoint without using a separate viewpoint sensing camera.

According to embodiments of the present invention, there is provided a system for controlling an IPTV service that may measure a lip-blowing of a user using a microphone of a mobile terminal, and perform a left-click, a right-click, a double click, and a drag and drop of a mouse depending on a type of the lip-blowing and thus, directly performing a desired operation of the user even without fixing a viewpoint of the user for a predetermined period of time.

According to embodiments of the present invention, there is provided a system for controlling an IPTV service that may control an IPTV using a mobile terminal where a touch screen is mounted and thus, performing an elaborate control on the IPTV using the touch screen.

According to embodiments of the present invention, there is provided a system for controlling an IPTV service that may perform a user authentication using an eyeball image of a user that is photographed by a mobile terminal and thus, may easily perform the user authentication even in a Set-Top Box (STB) which the user does not frequently use, to to thereby be readily provided with the IPTV services.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates an example of a system for controlling an Internet Protocol television (IPTV) service according to an embodiment of the present invention;

FIG. 2 is a flowchart illustrating an IPTV service authentication method according to an embodiment of the present invention;

FIG. 3 is a flowchart illustrating a method for controlling an IPTV service according to an embodiment of the present invention;

FIG. 4 is a flowchart illustrating a method for controlling an IPTV service according to another embodiment of the present invention; and

FIG. 5 is a flowchart illustrating a method for controlling an IPTV service according to still another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

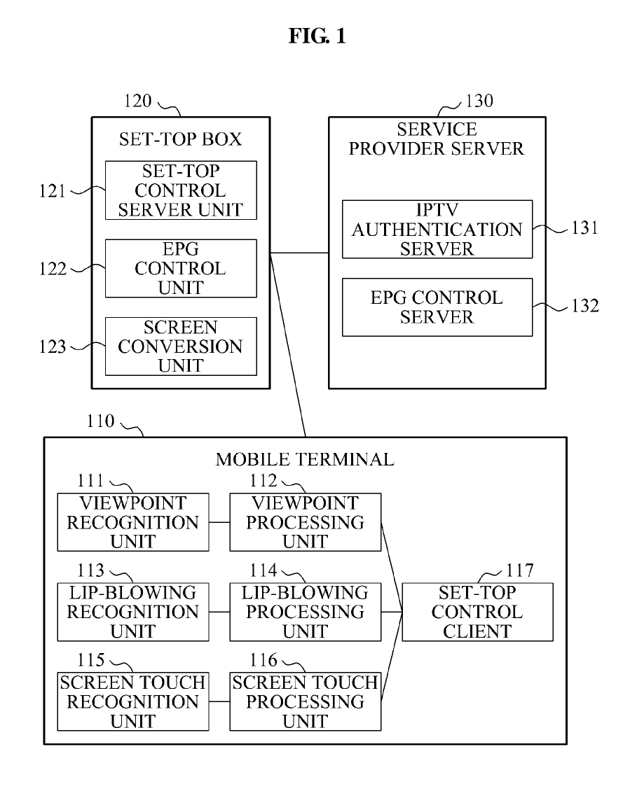

FIG. 1 illustrates an example of a system for controlling an Internet Protocol television (IPTV) service according to an embodiment of the present invention.

As illustrated in FIG. 1, the system according to an embodiment includes a mobile terminal 110 transmitting a control signal, a set-top box 120 displaying the IPTV service on a TV screen, and a service provider's server 130.

The mobile terminal 110 may transmit the control signal to the set-top box 120 in response to a request of a user, and control the IPTV service displayed on the TV screen. In this instance, the mobile terminal 110 may include a camera photographing a face of the user viewing the mobile terminal.

As illustrated in FIG. 1, the mobile terminal 110 includes a viewpoint recognition unit 111, a viewpoint processing unit 112, a lip-blowing recognition unit 113, a lip-blowing processing unit 114, a touch recognition unit 115, a touch processing unit 116, and a set-top control client 117.

The viewpoint recognition unit 111 may acquire information about a viewpoint where a user is viewing, using the camera. Specifically, the viewpoint recognition unit 111 may acquire face images by photographing the face of the user, and acquire information about the viewpoint by photographing an eyeball to acquire an eyeball image among the acquired face images. In this instance, the viewpoint recognition unit 111 may be the camera mounted in the mobile terminal 110.

The viewpoint processing unit 112 may calculate position coordinates corresponding to the viewpoint by comparing screen information of the mobile terminal 110 with the information about the viewpoint.

Specifically, the viewpoint processing unit 112 may calculate the position coordinates by comparing an image appearing in a center of the eyeball image with an image of a screen displayed on the mobile terminal.

The lip-blowing recognition unit 113 may measure a number of times a lip-blowing is performed by the user and a duration of the lip-blowing of the user, using a microphone.

The lip-blowing processing unit 114 may compute a desired selection method of the user by comparing the measured number of times the lip-blowing is performed and the measured duration of the lip-blowing with a predetermined setting. In this instance, the selection may include information about an operation selected from a plurality of operations by the user.

For example, as for the predetermined setting, when a lip-blowing performed in a relatively short period of time is set as a left-click operation of a mouse, a lip-blowing performed in a relatively long period of time is set as a right-click operation of the mouse, a lip-blowing performed once is set as a one-click operation of the mouse, and a lip-blowing consecutively performed twice is set as a double click operation of the mouse, the lip-blowing processing unit 114 may compute, as the selection, the above described operations of the mouse depending on a number of times the lip-blowing is performed by the user and a duration of the lip-blowing.

The touch recognition unit 115 may measure a number of times a touch is performed by the user using a touch screen, a duration of the touch, and a direction of the touch. In this instance, the touch recognition unit 115 may be a display that displays the screen information of the mobile terminal 110.

The touch processing unit 116 may compute a function selected by the user by comparing the measured number of times the touch is performed, the measured duration of the touch, and the measured direction of the touch with a predetermined setting.

The set-top control client 117 may display, on a display of the mobile terminal 110, the same screen as a screen of a television (TV) connected to the set-top box 120.

The set-top control client 117 may transmit, to the set-top box 120, the position coordinates calculated by the viewpoint processing unit 112, so that the set-top box 120 may display a selection icon on the same position as a position indicated by the position coordinates of the TV.

The set-top control client 117 may transmit, to the set-top box 120, the control function computed by the lip-blowing processing unit 114 or by the touch processing unit 116, so that the set top box 120 may perform the control method on the TV. The control method may be information about operations to be performed in the position coordinates of the TV.

Also, the set-top control client 117 may perform a service authentication of the user using the eyeball image acquired by the viewpoint recognition unit 111. Specifically, the set-top control client 117 may transmit, to the service provider's server 130 via the set-top box 120, the eyeball image acquired by the viewpoint recognition unit 111, so that the service authentication of the user may be performed in the service provider's server 130.

The set-top box 120 may control the IPTV service displayed on the TV screen, in accordance with the control signal received from the mobile terminal 110. In this instance, the IPTV service controlled by the set-top box 120 may include IPTV contents and an Electronic Program Guide (EPG).

As illustrated in FIG. 1, the set-top box 120 includes a set-top control server unit 121, an EPG control unit 122, and a screen conversion unit 123.

The set-top control server unit 121 may receive, from the mobile terminal 110, position information selected by a viewpoint of the user, and transmit the received position information to the EPG control unit 122.

The set-top control server unit 121 may receive, from the mobile terminal 110, the function inputted by the lip-blowing or the touch of the user, and transmit the received function to the EPG control unit 122.

When receiving the eyeball image from the mobile terminal 110, the set-top control server unit 121 may transmit the received eyeball image to the service provider's server 130, so that the service authentication of the user may be performed in the service provider's server 130.

The EPG control unit 122 may display the EPG on the TV screen, and further display the selection icon on the EPG based on the position information received from the set-top control server unit 121.

In this instance, the EPG control unit 122 may control an item of the EPG where the selection icon is positioned, based on the function received from the set-top control server unit 121.

For example, when the user performs the lip-blowing once while viewing a specific item of the EPG displayed on the mobile terminal 110, the viewpoint processing unit 112 may calculate the specific item of the EPG using the eyeball image of the user acquired by the viewpoint recognition unit 111, and the lip-blowing processing unit 114 may compute the control method corresponding to the one-click operation of the mouse based on the predetermined setting.

In this instance, when the set-top control client 117 transmits, to the set-top box 120, position information of the specific item of the EPG and the control method corresponding to the one-click operation of the mouse, the set-top control server unit 121 may receive the transmitted position information and control method, and transmit the received position information and control method to the EPG control unit 122.

Next, the EPG control unit 122 may display the selection icon on the specific item of the EPG where the user is viewing, based on the received position information, select the specific item of the EPG using the control method corresponding to the one-click operation of the mouse, and display, on the specific item of the EPG, information indicating the specific item of the EPG is selected using the control method corresponding to the one-click operation of the mouse.

The screen conversion unit 123 may convert the TV screen displayed by the EPG control unit 122 to an EPG image/data corresponding to a format of the mobile terminal 110, and transmit the converted EPG image/data to the mobile terminal 110. In this instance, the set-top control client 117 may display, on the mobile terminal 110, the same screen as the screen of the TV connected to the set-top box 120, using the EPG image/data received from the screen conversion unit 123.

The service provider's server 130 may store the IPTV contents and the EPG, and provide the stored IPTV contents and EPG to the set-top box 120.

In this instance, the service provider's server 130 may perform an authentication of the user using the eyeball image received from the set-top control server unit 121, and provide, to the set-top box 120, the IPTV contents and the EPG only when the service authentication of the user is successfully performed.

Specifically, an IPTV authentication server 131 of the service provider's server 130 may perform an authentication of the user when the eyeball image and an eyeball image included in user information that is stored in advance are the same based on a compared result between the two eyeball images.

Also, when the service authentication of the user is successfully performed in the IPTV authentication server 131, an EPG control server 132 of the service provider's server 130 may configure an optimized EPG for the user based on the stored user information, and transmit the configured optimized EPG to the set-top box 120.

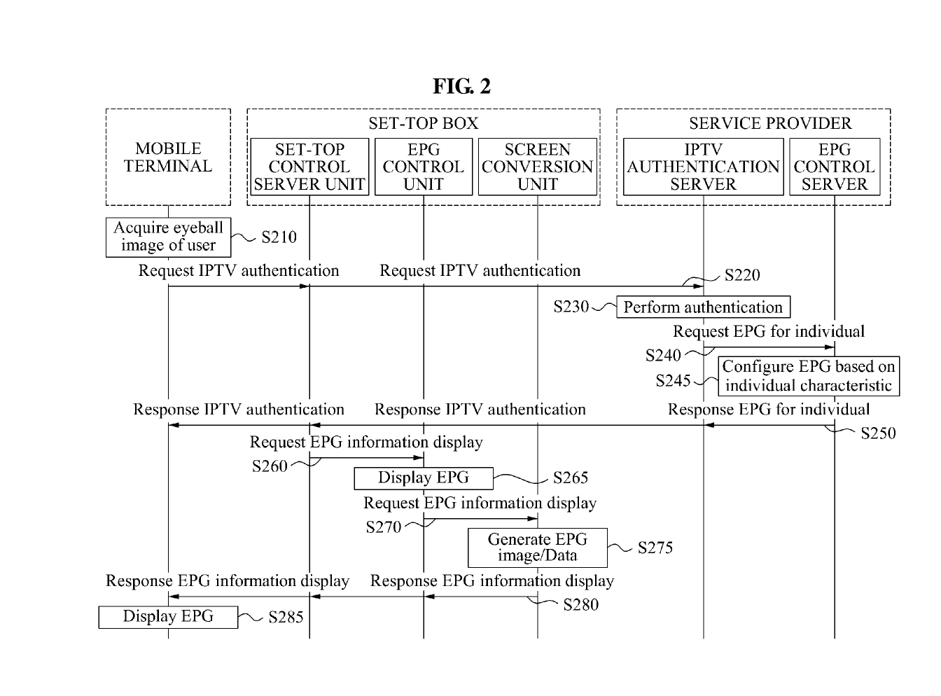

FIG. 2 is a flowchart illustrating an IPTV service authentication method according to an embodiment of the present invention.

In FIG. 2, a user may request an IPTV service authentication by viewing the mobile terminal 110.

In operation S210, the mobile terminal 110 may acquire an eyeball image of the user.

Specifically, when the user requests the IPTV service authentication while viewing the mobile terminal 110, and the set-top control client 117 that receives the request of the user requests the viewpoint recognition unit 111 to transmit an authentication image, the viewpoint recognition unit 111 may photograph a face of the user viewing the mobile terminal 110 to obtain face images, acquire the eyeball image among the face images, and transmit the acquired eyeball image to the set-top control client 117.

In operation S220, when the mobile terminal 110 transmits, to the set-top control server unit 121, the eyeball image acquired in operation S210 together with an identification (ID) of the user, the set-top control server unit 121 may transmit, to the service provider's server 130, an ID of the set-top box 120 together with the received eyeball image and ID of the user.

In operation S230, the IPTV authentication server 131 may perform an authentication of the user using the received eyeball image and ID of the user.

Specifically, the IPTV authentication server 131 may verify user information recorded by the user at the time of IPTV service subscription, using the ID of the user, and perform a service authentication when the eyeball image received in operation S220 and an eyeball image included in the user information are the same based on a compared result between the two eyeball images.

In operation S240, the IPTV authentication server 131 may request the EPG control server 132 to transmit an individual EPG of the user where the authentication of the user is successfully performed in operation S230.

In operation S245, the EPG control server 132 may configure an optimized EPG for the user based on user information of the user where the authentication of the user is successfully performed in operation S230.

In operation S250, the EPG control server 132 may transmit, to the IPTV authentication server 131, the optimized EPG configured in operation S245. In this instance, the IPTV authentication server 131 may transmit, to the set-top control server unit 121 of the set-top box 120, the received optimized EPG together with an authentication result for the user obtained in operation S230. Also, the set-top control server unit 121 may transmit, to the mobile terminal 110, the authentication result for the user and the optimized EPG

In operation S260, the set-top control server unit 121 may transmit, to the EPG control unit 122, the optimized EPG received in operation S250, and request a display of the EPG.

In operation S265, the EPG control unit 122 may display, on a TV screen, the optimized EPG received in operation S260.

In operation S270, the EPG control unit 122 may transmit, to the screen conversion unit 123, the EPG displayed on the TV screen in operation S265.

In operation S275, the EPG control unit 122 may convert, to EPG image/data corresponding to a format of the mobile terminal 110, the EPG displayed on the TV screen in operation S270.

In operation S280, the EPG control unit 122 may transmit, to the mobile terminal 110, the converted EPG image/data.

In operation S285, the mobile terminal 110 may display the same screen as a screen of a TV connected to the set-top box 120, using the EPG image/data received from the screen conversion unit 123.

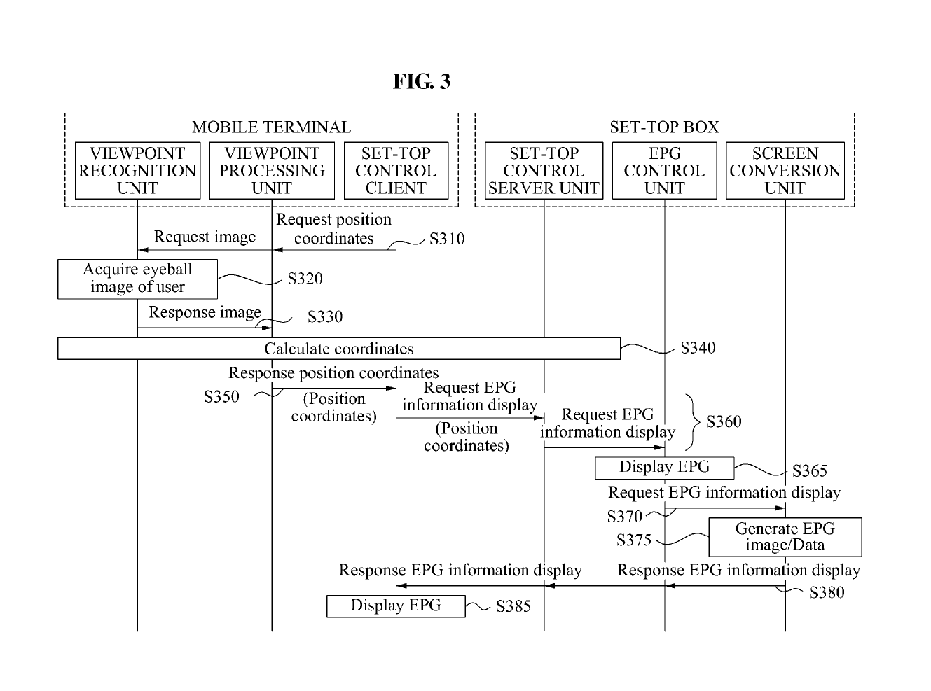

FIG. 3 is a flowchart illustrating a method for controlling an IPTV service according to an embodiment of the present invention.

Specifically, FIG. 3 is a flowchart illustrating the method for controlling the IPTV service that may display an item of an EPG selected by a user, using a viewpoint of the user.

According to an embodiment, using the mobile terminal where a camera is mounted without adding a separate viewpoint verifying device to the set-top box 120, a position of a screen where the user is viewing may be computed to select a desired item of the user.

In operation S310, when the set-top control client 117 requests the viewpoint processing unit 112 to transmit position coordinates, the viewpoint processing unit 112 may request the viewpoint recognition unit 111 to transmit an eyeball image.

In operation S320, the viewpoint recognition unit 111 may photograph a face of the user viewing the mobile terminal 110, in response to a request of operation S310, to obtain face images, and acquire the eye ball image among the face images.

In operation S330, the viewpoint recognition unit 111 may transmit, to the viewpoint processing unit 112, the eyeball image acquired in operation S320.

In operation S340, the viewpoint processing unit 112 may compute position coordinates of a viewpoint where the user is viewing by comparing the eyeball image acquired in operation S330 with a screen displayed on the mobile terminal 110.

Specifically, the viewpoint processing unit 112 may compute the position coordinates of the viewpoint by comparing an image appearing in a center of the eyeball image with an image of a screen displayed on the mobile terminal 110.

In operation S350, the viewpoint processing unit 112 may transmit, to the set-top control client 117, the position coordinates computed in operation S340.

In operation S360, the set-top control client 117 may transmit, to the set-top control server unit 121, an EPG information display requesting signal. In this instance, the set-top control server unit 121 may transmit, to the EPG control unit 122, the received EPG information display requesting message.

In this instance, the EPG information display requesting signal may include the position coordinates received in operation S350.

In operation S365, the EPG control unit 122 may display, on a TV screen, EPG information based on the EPG information display requesting signal received in operation S360, and display a selection icon on the same position as a position of the position coordinates.

In operation S370, the EPG control unit 122 may transmit, to the screen conversion unit 123, the EPG information displayed on the TV screen in operation S365. In this instance, the EPG information displayed on the TV screen may be EPG information where the selection icon is displayed on the same position as the position of the position coordinates.

In operation S375, the EPG control unit 122 may convert, to EPG image/data corresponding to a format of the mobile terminal 110, the EPG information displayed on the TV screen in operation S365.

In operation S380, the EPG control unit 122 may transmit, to the mobile terminal 110, the EPG image/data converted in operation S375.

In operation S385, the mobile terminal 110 may display the same screen as a screen of a TV connected to the set-top box 120, using the EPG image/data received from the screen conversion unit 123.

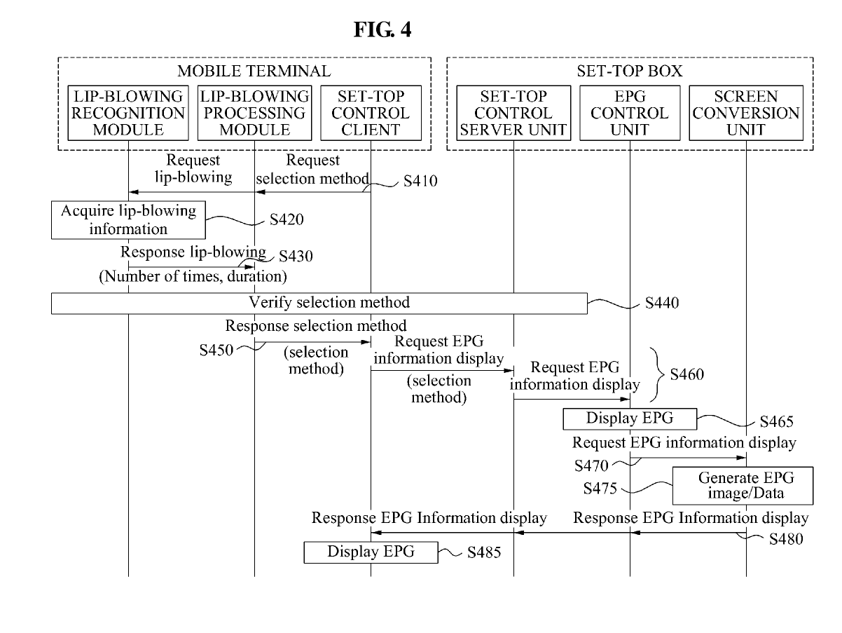

FIG. 4 is a flowchart illustrating a method for controlling an IPTV service according to another embodiment of the present invention.

Specifically, FIG. 4 is a flowchart illustrating the method for controlling the IPTV service that may perform an item of an EPG selected by a user, using a lip-blowing performed by the user.

According to an embodiment, a desired position of the user may be selected by a viewpoint of the user, and an operation selected using the lip-blowing of the user may be inputted, so that a desired operation of the user may be directly performed without fixing the viewpoint of the user for a predetermined period of time.

In operation S410, when the set-top control client 117 requests the lip-blowing processing unit 114 to transmit a selection, the lip-blowing processing unit 114 may request the lip-blowing recognition unit 113 to transmit lip-blowing information.

In operation S420, the lip-blowing recognition unit 113 may acquire the lip-blowing information by measuring a number of times a lip-blowing is performed by the user and a duration of the lip-blowing of the user, using a microphone.

In operation S430, the lip-blowing recognition unit 113 may transmit, to the lip-blowing processing unit 114, the lip-blowing information acquired in operation S420.

In operation S440, the lip-blowing processing unit 114 may compute a desired selection method of the user by comparing the lip-blowing information received in operation S430 with a predetermined setting.

For example, as for the predetermined setting, when a lip-blowing performed in a relatively short period of time is set as a left-click operation of a mouse, a lip-blowing performed in a relatively long period of time is set as a right-click operation of the mouse, a lip-blowing performed once is set as a one-click operation of the mouse, and a lip-blowing consecutively performed twice is set as a double click operation of the mouse, the lip-blowing processing unit 114 may compute, as the selection, the above described operations of the mouse depending on a number of times the lip-blowing is performed by the user and a duration of the lip-blowing.

In operation S450, the lip-blowing processing unit 114 may transmit, to the set-top control client 117, the selection method computed in operation S440.

In operation S460, the set-top control client 117 may transmit, to the set-top control server unit 121, an EPG information display requesting message. In this instance, the set-top control server unit 121 may transmit, to the EPG control unit 122, the received EPG information display requesting message.

In this instance, the EPG information display requesting signal may include the selection method received in the operation S450.

In operation S465, the EPG control unit 122 may display, on a TV screen, the EPG based on the EPG information display requesting signal received in operation S460, and perform one of items of the EPG based on the selection method.

In operation S470, the EPG control unit 122 may transmit, to the screen conversion unit 123, the EPG information displayed on the TV screen in operation S465. In this instance, the EPG information displayed on the TV screen may be a screen where one of the items of the EPG is performed based on the selection method.

In operation S475, the EPG control unit 122 may convert, to EPG image/data corresponding to a format of the mobile terminal 110, the EPG information displayed on the TV screen.

In operation S480, the EPG control unit 122 may transmit, to the mobile terminal 110, the EPG image/data converted in operation S475.

In operation S485, the mobile terminal 110 may display the same screen as a screen of a TV connected to the set-top box 120, using the EPG image/data received from the screen conversion unit 123.

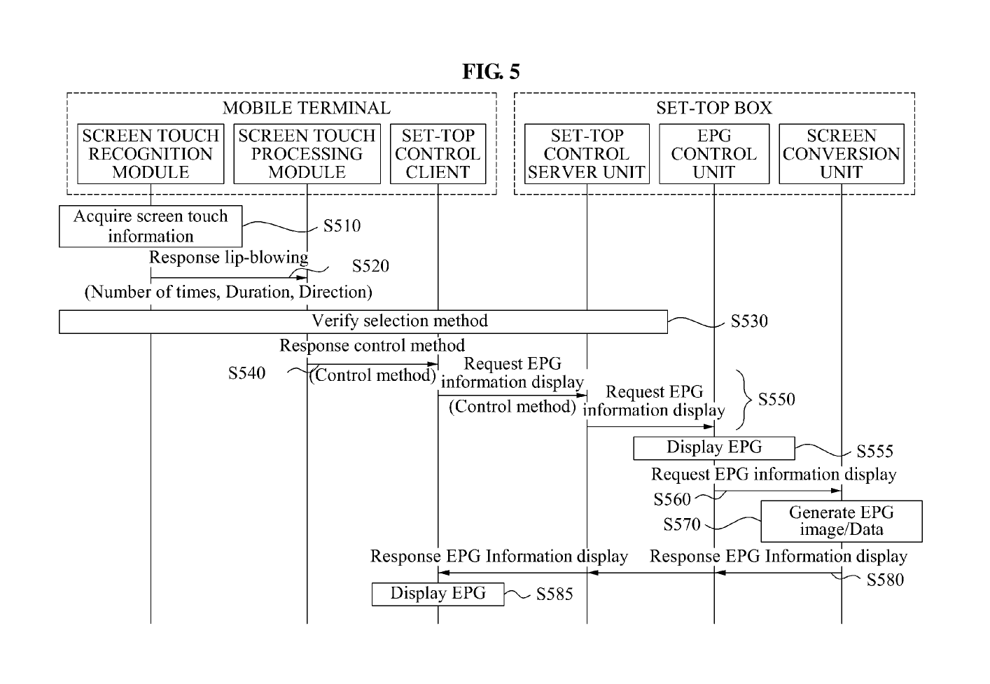

FIG. 5 is a flowchart illustrating a method for controlling an IPTV service according to still another embodiment of the present invention.

Specifically, FIG. 5 is a flowchart illustrating the method for controlling the IPTV service that may select a user's desired item of an EPG using a touch screen, and perform the selected item.

According to an embodiment, using the mobile terminal 110 where the touch screen is mounted, the user's desired item may be easily selected, and may elaborately control a method where the selected item is performed.

In operation S510, the touch recognition unit 115 may measure a number of times a touch is performed by the user, a duration of the touch, and a direction of the touch to acquire touch information. In this instance, the touch recognition unit 115 may be a touch screen. Also, the touch recognition unit 115 may display the same screen as a screen of a TV connected to the set-top box 120 in operation S285.

In operation S520, the touch recognition unit 115 may transmit, to the touch processing unit 116, the touch information acquired in operation S520.

In operation S530, the touch processing unit 116 may compute a desired control method of the user by comparing the touch information acquired in operation S520 with a predetermined setting.

For example, as for the predetermined setting, when a movement to a right side is set as an operation of pressing a right arrow, a movement to a left side is set as an operation of pressing a left arrow, and retracting and spreading two fingers is set as an operation of zoom-in, the touch processing unit 116 may compute, as the function, a control command of a position selected by the touch of the user depending on the direction of the touch or a movement path of the touch.

In operation S540, the touch processing unit 116 may transmit, to the set-top control client 117, the function computed in operation S530.

In operation S550, the set-top control client 117 may transmit, to the set-top control server unit 121, an EPG information display requesting signal. In this instance, the set-top control server unit 121 may transmit, to the EPG control unit 122, the received EPG information display requesting signal.

In this instance, the EPG information display requesting signal may include the function compute in operation S530.

In operation S555, the EPG control unit 122 may display, on a TV screen, the EPG based on the EPG information display requesting signal received in operation S550, and change a state of the EPG based on the control method. For example, when the control method is the operation of the zoom-in, a position where a touch starts to be performed may be zoomed-in.

In operation S560, the EPG control unit 122 may transmit, to the screen conversion unit 123, the EPG information displayed on the TV screen in operation S555. In this instance, the EPG information displayed on the TV screen may be a screen where the EPG is changed based on the control method.

In operation S570, the EPG control unit 122 may convert, to EPG image/data corresponding to a format of the mobile terminal 110, the EPG information displayed on the TV screen in operation S555.

In operation S580, the EPG control unit 122 may transmit, to the mobile terminal 110, the EPG image/data converted in operation S570.

In operation S585, the mobile terminal 110 may display the same screen as a screen of a TV connected to the set-top box 120, using the EPG image/data received from the screen conversion unit 123.

As described above, according to an embodiment, the system for controlling the IPTV service may measure a viewpoint where a user is viewing, using a mobile terminal and thus, control an IPTV using the viewpoint without using a separate viewpoint sensing camera.

According to an embodiment, the system for controlling the IPTV service may measure a lip-blowing of a user using a microphone of a mobile terminal, and perform a left-click, a right-click, a double click, and a drag and drop of a mouse depending on a type of the lip-blowing and thus, directly performing a desired operation of the user even without fixing a viewpoint of the user for a predetermined period of time.

According to an embodiment, the system for controlling the IPTV service may control an IPTV using a mobile terminal where a touch screen is mounted and thus, performing an elaborate control on the IPTV using the touch screen.

According to an embodiment, the system for controlling the IPTV service may perform a user authentication using an eyeball image of a user that is photographed by a mobile terminal and thus, easily perform the user authentication even in a Set-Top Box (STB) which the user does not frequently use, to thereby be readily provided with the IPTV services.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A mobile terminal for controlling a set-top box, the mobile terminal comprising:
a viewpoint recognition unit to obtain information about a viewpoint where a user is viewing;
a viewpoint processing unit to compute position coordinates corresponding to the viewpoint by comparing a screen displayed on the mobile terminal with the information about the viewpoint; and
a set-top control client to display the same screen as a screen of a television (TV) on to the mobile terminal, and to enable the set-top box to display a selection icon on the same position as a position indicated by the position coordinates of the TV.

2. The mobile terminal of claim 1, wherein the information about the viewpoint is an eyeball image of the user.

3. The mobile terminal of claim 2, wherein the viewpoint processing unit computes the position coordinates based on the viewpoint by comparing an image appearing in a center of the eyeball image with an image of the screen displayed on the mobile terminal.

4. The mobile terminal of claim 2, wherein the set-top control client performs a service authentication of the user using the eyeball image obtained by the viewpoint recognition unit.

5. The mobile terminal of claim 1, further comprising:
a lip-blowing recognition unit to measure a number of times a lip-blowing is performed by the user and a duration of the lip-blowing of the user; and
a lip-blowing processing unit to compute a control command selected by the user by comparing the measured number of times the lip-blowing is performed and the measured duration of the lip-blowing with a predetermined setting,
wherein the set-top control client transmits the control command to the set-top box to enable the set-top box to execute the control command in the TV.

6. The mobile terminal of claim 3, further comprising:
a touch recognition unit to measure a number of times a touch is performed by the user, a duration of the touch, and a direction of the touch, and
a touch processing unit to compute a control command selected by the user by comparing the measured number of times the touch is performed, the measured duration of the touch, and the measured direction of the touch with a predetermined setting,
wherein the set-top control client transmits the control command to the set-top box to enable the set-top box to execute the control command in the TV.

7. The mobile terminal of claim 5, wherein the control command is information about an operation to be performed in the position coordinates of the TV.

8. A set-top box, comprising:
a set-top control server unit to receive, from a mobile terminal, position information selected by a user based on a viewpoint of the user;
an Electronic Program Guide (EPG) control unit to display an EPG on a TV screen, and to further display a selection icon on the EPG based on the position information; and
a screen conversion unit to convert the TV screen displayed by the EPG control unit to an EPG image/data corresponding to a format of the mobile terminal, and to transmit the converted EPG image/data to the mobile terminal.

9. The set-top box of claim 8, wherein the mobile terminal displays the EPG image, and recognizes, as the position information, a position where the user is viewing from among the EPG images to transmit the recognized position information to the set-top box.

10. The set-top box of claim 8, wherein the set-top control server unit receives, from the mobile terminal, a control command inputted by the user using a lip-blowing or a touch of the user, and controls an EPG item where the selection icon is positioned, based on the control command.

11. The set-top box of claim 8, wherein, when receiving an eyeball image of the user from the mobile terminal, the set-top control server unit transmits the eyeball image to a server of a service provider where information about the user is stored, and receives a service authentication of the user from the server of the service provider.

12. The set-top box of claim 11, wherein the server of the service provider compares the eyeball image received from the set-top control server with an eyeball image included in the information about the user, and performs the service authentication of the user when the compared eyeball images are the same.

13. The set-top box of claim 12, wherein, when performing the service authentication of the user, the server of the service provider configures an optimized EPG for the user based on the information about the user, and transmits the optimized EPG to the set-top box.

14. A method for controlling an Internet Protocol Television (IPTV) service, the method comprising:
displaying, by a mobile terminal, the same screen as a screen of a TV;
measuring, by the mobile terminal, a viewpoint of a user;
computing, by the mobile terminal, position coordinates based on the viewpoint by comparing the viewpoint with screen information displayed on the mobile terminal; and
transmitting, by the mobile terminal, the position coordinates to a set-top box to enable the set-top box to display a selection icon on the same position as a position indicated by the position coordinates of the TV.

15. The method of claim 14, wherein the measuring comprises measuring, by the mobile terminal, the viewpoint by obtaining the eyeball image of the user.

16. The method of claim 15, wherein the computing comprises computing, by the mobile terminal, the position coordinates based on the viewpoint by comparing an image appearing in a center of the eyeball image with an image of a screen of the mobile terminal.

17. The method of claim 14, further comprising:
measuring, by the mobile terminal, a number of times a lip-blowing is performed by the user, and a duration of the lip-blowing;
computing, by the mobile terminal, a control command by comparing the measured number of times the lip-blowing is performed and the measured duration of the lip-blowing with a predetermined setting; and
transmitting, by the mobile terminal, the control command to the set-top box to enable the set-top box to execute the control command in a position where the selection icon is displayed on the TV screen.

18. The method of claim 14, further comprising:
measuring, by the mobile terminal, a number of times a touch is performed by the user, a duration of the touch, and a direction of the touch;
computing, by the mobile terminal, a control command by comparing the measured number of times the touch is performed, the measured duration of the touch, and the measured direction of the touch with a predetermined setting; and
transmitting, by the mobile terminal, the control command to the set-top box to enable the set-top box to execute the control command in a position where the selection icon is displayed on the TV screen.
